(19) United States
(12) Patent Application Publication
(10) Pub. No.: US 2008/0238696 A1
(43) Pub. Date: Oct. 2, 2008

(54) Warning device and method

(76) Inventors: Joseph Amorini, Heathrow, FL (US); John Telesca, Holtsville, NY (US)

Correspondence Address: JAMES RAY & ASSOCIATES, 2640 PITCAIRN ROAD, MONROEVILLE, PA, 15146, US

(21) Appl. No.: 12/079,138

(22) Filed: Mar. 25, 2008

Related U.S. Application Data
(60) Provisional application No. 60/920,485, filed on Mar. 28, 2007.

(51) Int. Cl. G01W 1/00

(52) U.S. Cl. 340/601

(57) ABSTRACT

A warning device including a transmitting mechanism for transmitting a signal indicative of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation. A first power source is operably connected to such transmitting mechanism for supplying power to such transmitting mechanism. A receiving mechanism receives such signal from such transmitting mechanism. An alarm mechanism is operably connected to the receiving mechanism such that when the receiving mechanism receives such signal from such transmitting mechanism, such alarm mechanism will produce at least one of a predetermined sound, motion and visual display. A second power source is operably connected to such receiving mechanism and the alarm mechanism for supplying power thereto.

### CROSS REFERENCE TO RELATED APPLICATION

This patent application is related to and claims priority from U.S. Provisional Patent Application Ser. No. 60/920,485 filed Mar. 28, 2007.

### FIELD OF THE INVENTION

The present invention relates, in general, to alarm devices and, more particularly, this invention relates to devices which warn people of weather conditions, fires, and other dangerous situations.

### BACKGROUND OF THE INVENTION

Prior to the conception and development of the present invention, alarm whistles and emergency broadcasts, as are generally well known in the prior art, have been used in attempts to warn the public about dangerous conditions such as tornados and the like. Unfortunately, these types of warnings can easily go unnoticed. Furthermore, such warnings are often disseminated to persons unaffected by the event generating such warnings thereby resulting in confusion, inconvenience, upset, and chaos. Moreover, such warnings are often implemented too late for the recipients to prepare themselves for the warning triggering event.

Specifically of interest to the present invention are the following: Permut, et al, U.S. Pat. No. 4,153,881, provides a system for giving advanced warning of probable flash floods and/or stage floods to potential flood victims by collecting and analyzing rainfall and stream level data, and by providing means for disseminating alarms and instructions to individuals in threatened areas.

Flanagan, U.S. Pat. No. 5,910,763, provides a system that gives an area warning to a specific general population of an earthquake prior to the arrival of the hazardous ground motion typically associated with earthquakes, and of approaching natural disasters that could impact an area. Local station detector sites are equipped with earthquake seismic motion detectors and microprocessors. A warning instruction is transmitted to initiate transmission of local area warnings.

Leichner, U.S. Pat. No. 6,002,748, discloses a system whereby local telephone exchanges in a threatened geographical area connect to their subscribers and transmit a recorded warning message. This is done in response to transmission of threat data communicated from one of several remote computer terminals to a central computer.

Vinson, U.S. Pat. No. 6,594,345, provides a system and method for providing early warning notifications to telephone subscribers having calling number delivery service. The system uses an advanced intelligent network to initiate several calls in rapid succession to all calling number delivery subscribers located within a pre-determined geographic area. A code identifying the disaster warning message is transmitted to the subscribers' calling number delivery systems in place of an actual calling line identification. Subscribers having calling name delivery service receive the disaster code and a text message briefly describing the disaster warning.

Lamb, U.S. Pat. No. 6,329,904, provides an apparatus, including an alert device having a receiver for receiving location-specific alert information broadcast via particular telecommunication transmitters operating within a cellular, PCS, or other wireless telecommunications network, thereby allowing delivery of a location-specific message to a user without requiring the input of data representative of the location of the alert device's receiver. The alert device includes a receiver for receiving digital messages in the form of broadcast short messages on a digital control channel, a microcomputer having a monitoring circuit that monitors received digital messages for the presence of an alert code associated with alert messages regarding an alert condition, and a plurality of peripheral devices which produce various tones and flashing lights in response to the alert device's reception of an appropriate alert message.

Kolsrud, U.S. Pat. No. 7,039,386, discloses a broadcast method in which an emergency broadcast station receives report of an impending or current disaster-related situation from a local authority. The geographic area to be affected by the impending or current disaster-related situation is served by an existing communication system, such as a cellular network. The emergency broadcast station generates a signal representing an emergency broadcast message that contains a frequency of an accessible main emergency channel at the emergency broadcast station, and a priority level classifying the emergent or impending disaster-related situation. The signal is transmitted to one or base stations, each serving a plurality of users of the system, which in turn send the signal to the users. The users tune to the frequency of the channel to receive the emergency broadcast message.

### SUMMARY OF THE INVENTION

The present invention provides a warning device. Such warning device includes a transmitting means for transmitting a signal indicative of at least one of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation. A first power source is operably connected to such transmitting means for supplying power to such transmitting means. A receiving means receives the signal from such transmitting means. An alarm means is operably connected to the receiving means such that when the receiving means receives the signal from such transmitting means the alarm means will produce at least one of a predetermined sound, motion and visual display. A second power source is operably connected to the receiving means and the alarm means for supplying power thereto.

According to another embodiment, a method of providing a warning is provided. Such method includes providing a transmitting means for transmitting a signal indicative of at least one of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation. Providing a first power source operably connected to such transmitting means for supplying power to such transmitting means. Providing a receiving means for receiving the signal from such transmitting means. Providing an alarm means operably connected to the receiving means for providing an alarm when the receiving means receives a signal from such transmitting means. Providing a second power source operably connected to such receiving means and such alarm means for supplying power thereto. Transmitting a signal from such transmitting means to the receiving means such that when the receiving means receives the signal from such transmitting means the alarm means will produce at least one of a predetermined sound, a predetermined motion and a predetermined visual display.

### OBJECTS OF THE INVENTION

It is, therefore, one of the primary objects of the present invention to provide a warning device which provides a warning of a specific event or happening to persons occupying homes, businesses, and public locations.

Another object of the present invention is to provide a warning device which can be activated to provide a warning to a specific group of people and locations.

Still another object of the present invention is to provide a device which will be effective in communicating a warning regarding a dangerous situation such as a fire, inclement weather, flooding, a tornado, a cyclone, a hurricane, a tsunami, a tidal wave, a microburst, a blizzard, an ice storm, hail, an Amber alert, terrorist attacks, rioting, landslide, volcano eruption, a roadway emergency, other emergency conditions, and the like.

Yet another object of the present invention is to provide a method to implement a warning which can be used to reach many persons and locations as well as just one person and location.

An additional object of the present invention is to provide a warning system which can be implemented to reach people through the use of cable boxes, satellite dish receivers, internet service providers, digital television, land lines telephone, cell phones, mobile communication devices, and the like.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial schematic view of one embodiment of the invention.

FIG. 2 is a partial perspective view of one embodiment of the invention in which the receiving means, alarm means, and second power source are at least one of housed within and operably connected to a cable box.

FIG. 3 is a partial schematic view of one embodiment of the invention in which the invention includes at least one light member.

FIG. 4 is a partial perspective view of the invention in which the invention includes at least one light member, a plurality of apertures for releasing sound emitted by the alarm means, and an access panel for providing access to the second power source.

FIG. 5 is a partial perspective view of the invention according to one embodiment of the invention in which the receiving means, alarm means, and second power source are at least one of housed within and operably connected to at least one of a cell phone and a mobile communication device.

FIG. 6 is a partial perspective view of the invention according to one embodiment of the invention in which the receiving means, alarm means, and second power source are at least one of housed within and operably connected to a computer.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

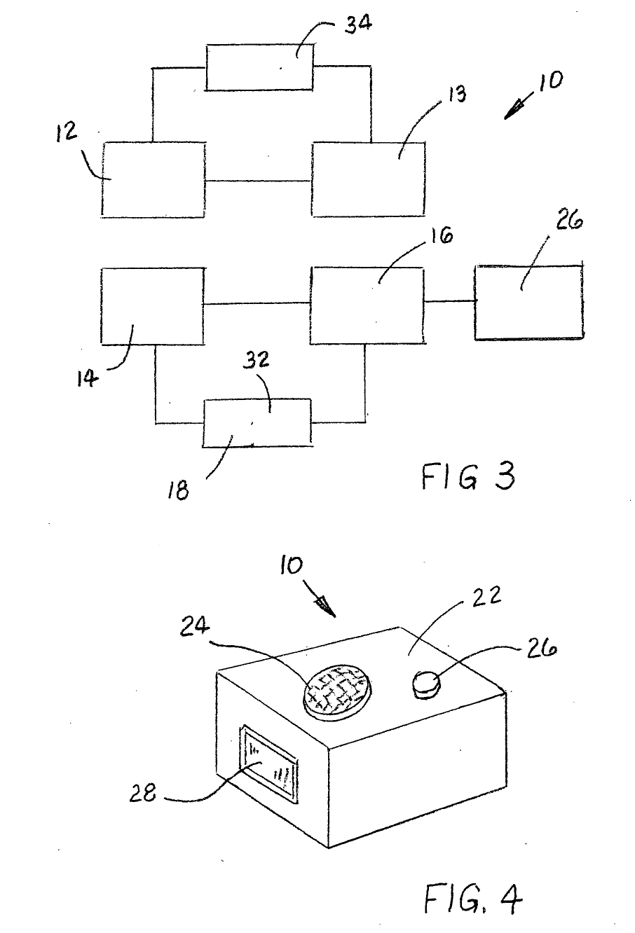

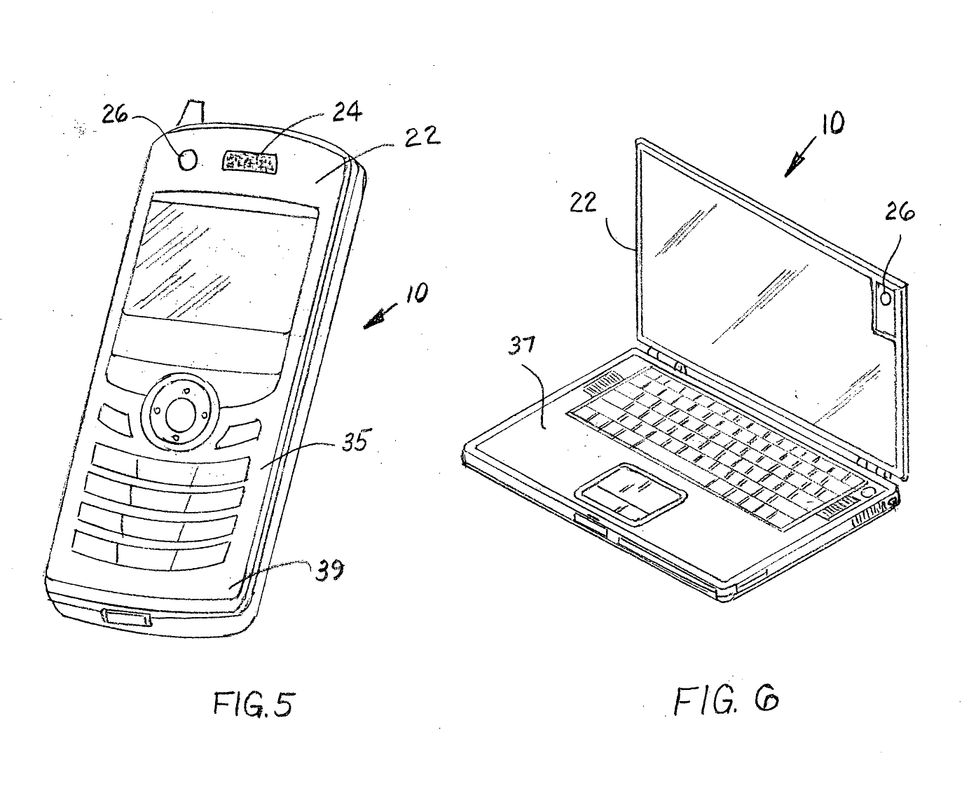

Reference is now made, more particularly, to FIGS. 1-6.

Referring to FIG. 1, a warning device, generally designated 10, is provided. Such warning device 10 includes a transmitting means 12 for transmitting a signal indicative of at least one of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation. A first power source 13 is operably connected to such transmitting means for supplying power to such transmitting means.

A receiving means 14 receives such signal from such transmitting means 12. An alarm means 16 is operably connected to the receiving means 14 such that when the receiving means 14 receives the signal from such transmitting means 12 the alarm means 16 will produce at least one of a predetermined sound, motion, and visual display.

A second power source 18 is operably connected to the receiving means 14 and the alarm means 16 for supplying power thereto.

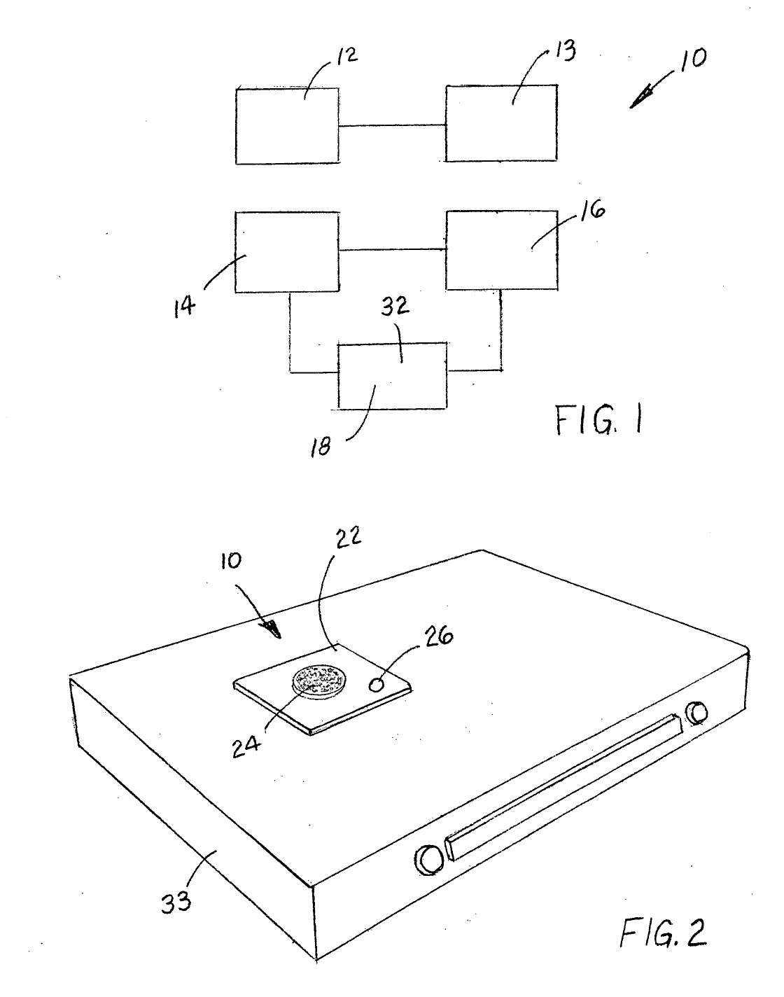

Referring to FIGS. 2-6, it is presently preferred that the receiving means 14, the alarm means 16, and the second power source 18 are contained within a housing 22 manufactured from a first predetermined material and having a first predetermined size and a first predetermined shape. It is further presently preferred that such housing 22 includes a plurality of apertures 24 for releasing sound emitted by the alarm means 16.

It is presently preferred that such housing 22 includes at least one light member 26 disposed at a predetermined location thereon and operably connected to the second power source 18 and the alarm means 16 such that when such alarm means 16 produces such visual display the at least one light member 26 will be energized.

It is also presently preferred that such housing 22 includes an access panel 28 releasably attached to such housing 22 to provide access to remove the second power source 18 as necessary.

It is presently preferred that such second power source 18 is at least one battery 32. It is further presently preferred that such at least one battery 32 is rechargeable.

It is presently preferred that the receiving means 14, the alarm means 16, and the second power source 18 are at least one of housed within and operably connected to at least one of a cable box 33, a satellite dish receiver, a computer 37, a television, a telephone, a cell phone 35, and a mobile communication device 39.

It is presently preferred that such warning device further includes a computer data system 34 capable of analyzing weather, such computer data system 34 being operably connected to such transmitting means 12 such that upon such computer data system 34 analyzing such weather and recognizing a predetermined configuration of weather elements such computer data system 34 will activate such transmitting means 12.

According to another embodiment, a method of providing a warning is provided. Such method includes providing a transmitting means for transmitting a signal indicative of at least one of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation.

Providing a first power source operably connected to such transmitting means for supplying power to such transmitting means.

Providing a receiving means for receiving the signal from such transmitting means.

Providing an alarm means operably connected to the receiving means for providing an alarm when the receiving means receives a signal from such transmitting means.

Providing a second power source operably connected to the receiving means and the alarm means for supplying power thereto.

Transmitting a signal from such transmitting means to such receiving means such that when the receiving means receives the signal from such transmitting means the alarm means will produce at least one of a predetermined sound, a predetermined motion and a predetermined visual display.

It is presently preferred that such method of providing a warning includes operably connecting at least one of the receiving means, the alarm means, and the second power source to at least one of a cable box, a satellite dish receiver, a computer, a television, a telephone, a cell phone, and a mobile communication device.

It is further presently preferred that such method for providing a warning further includes providing a computer data system capable of analyzing weather and connecting the computer data system to such transmitting means such that upon such computer data system analyzing such weather and recognizing a predetermined configuration of weather elements such computer data system will active such transmitting means.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A warning device comprising:
a. a transmitting means for transmitting a signal indicative of at least one of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation;
b. a first power source operably connected to said transmitting means for supplying power to said transmitting means;
c. a receiving means for receiving said signal from said transmitting means;
d. an alarm means operably connected to said receiving means such that when said receiving means receives said signal from said transmitting means said alarm means will produce at least one of a predetermined sound, motion and visual display; and
e. a second power source operably connected to said receiving means and said alarm means for supplying power thereto.

2. A warning device according to claim 1 wherein said receiving means, said alarm means, and said second power source are contained within a housing manufactured from a first predetermined material and having a first predetermined size and a first predetermined shape.

3. A warning device according to claim 2 wherein said housing includes a plurality of apertures for releasing sound emitted by said alarm means.

4. A warning device according to claim 1 wherein said second power source is at least one battery.

5. A warning device according to claim 4 wherein said at least one battery is rechargeable.

6. A warning device according to claim 2 wherein said housing includes an access panel releasably attached to said housing to provide access to remove said second power source as necessary.

7. A warning device according to claim 2 wherein said housing includes at least one light member disposed at a predetermined location thereon and operably connected to said second power source and said alarm means such than when said alarm means produces said visual display said at least one light member will be energized.

8. A warning device according to claim 1 wherein at least one of said receiving means, said alarm means, and said second power source are at least one of housed within and operably connected to at least one of a cable box, a satellite dish receiver, a computer, a television, a telephone, a cell phone, and a mobile communication device.

9. A warning device according to claim 1 wherein said warning device further includes a computer data system capable of analyzing weather, said computer data system being operably connected to said transmitting means such that upon such computer data system analyzing such weather and recognizing a predetermined configuration of weather elements such computer data system will active said transmitting means.

10. A method of providing a warning comprising the steps of:
a. providing a transmitting means for transmitting a signal indicative of at least one of a fire, inclement weather, flooding, a tornado, a cyclone, a hurricane, a tsunami, a tidal wave, a microburst, a blizzard, an ice storm, a hail storm, an Amber alert, a terrorist attack, a riot, a landslide, a volcano eruption, a roadway emergency, and an emergency situation;
b. providing a first power source operably connected to said transmitting means for supplying power to said transmitting means;
c. providing a receiving means for receiving said signal from said transmitting means;
d. providing an alarm means operably connected to said receiving means for providing an alarm when said receiving means receives a signal from said transmitting means;
e. providing a second power source operably connected to said receiving means and said alarm means for supplying power thereto; and
f. transmitting a signal from said transmitting means to said receiving means such that when said receiving means receives said signal from said transmitting means said alarm means will produce at least one of a predetermined sound, a predetermined motion and a predetermined visual display.

11. A method of providing a warning according to claim 10 wherein said method further includes operably connecting at least one of said receiving means, said alarm means, and said second power source to at least one of a cable box, a satellite dish receiver, a computer, a television, a telephone, a cell phone, and a mobile communication device.

12. A method of providing a warning according to claim 10 wherein said method further includes providing a computer data system capable of analyzing weather and connecting said computer data system to said transmitting means such that upon such computer data system analyzing such weather and recognizing a predetermined configuration of weather elements such computer data system will active said transmitting means.
